(19) United States
(12) Patent Application Publication
(10) Pub. No.: US 2005/0092920 A1
(43) Pub. Date: May 5, 2005

(54) Three-dimensional surface analyzing method

(75) Inventors: Jae-cheol Lee, Gyeonggi-do (KR); Igor Asanov, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/949,523

(22) Filed: Sep. 27, 2004

(30) Foreign Application Priority Data
Nov. 5, 2003 (KR) 10-2003-0078092

(51) Int. Cl. H01J 40/00; H01J 47/00

(52) U.S. Cl. 250/305

(57) ABSTRACT

Provided is a method of analyzing a surface three-dimensionally in which compositions of a surface and an inner of a specimen are analyzed in three dimensions in a device having a beam source; a monochromator which separates a specific-wavelength beam from a multi-wavelength beam emitted from the beam source and irradiates the detected specific-wavelength beam into the specimen; a detector which analyzes energy of photoelectrons that are excited and escaped from the specimen, the method comprising: irradiating the specific-wavelength beam into one region of the surface of the specimen to measure intensities of the excited photoelectrons depending on escape angles between a normal line to the surface of the specimen and the escape directions of the excited photoelectrons, and detecting a composition distribution depending on a depth of the one region of the specimen by using data on the intensities that are measured depending on the escape angles of the excited photoelectrons; changing an incident position of the specific-wavelength beam for the specimen to detect the composition distribution depending on the depth at each of positions of the surface of the specimen; and collecting data on the composition distribution depending on the depth at each of the positions of the specimen to analyze the compositions of the specimen in the three dimensions.

### BACKGROUND OF THE INVENTION

This application claims the priority of Korean Patent Application No. 2003-78092, filed on Nov. 5, 2003, in the Korean Intellectual Property Office, the disclosure of which is incorporated herein in its entirety by reference.

1. Field of the Invention

The present invention relates to a method of analyzing a surface three-dimensionally, and more particularly to a method for analyzing the surface of a specimen in three dimensions by using Angle-Resolved X-ray Photoelectron Spectroscopy (ARXPS) that is Electron Spectroscopy for Chemical Analysis (ESCA).

2. Description of the Related Art

As a variety of new materials are developed and devices with a nano-meter level of thin film are developed, surface analysis is of increasing concern. That is because physical or chemical reaction occurs at the surface of material earlier than at the inner of material due to the constant contact of a surface of material with the external. Surface analysis is a technique for investigating a constituent element, a chemical bonding state, an energy level or the like at the depth of about 20 Å of material such as metal with a surface being hard, and at the depth of about 100 Å of material such as organic matter or polymer. The surface analysis plays an important role in studying all the newest materials.

As the surface analysis, which is widely used and well known, there are X-ray Photoelectron Spectroscopy (XPS), Auger Electron Spectroscopy (AES), Secondary Ion Mass Spectroscopy (SIMS) and the like.

The AES performs sputtering for a specimen to analyze the surface of the specimen, but has a drawback in that a film quality of the specimen is deteriorated, thereby making it difficult to exactly analyze the specimen.

The XPS is a method for non-destructive surface analysis unlike the AES. When photons are incident on the specimen, electrons are escaped from atom or molecule. The energy of the escaped electrons is measured to analyze the surface of the specimen. The XPS is known as Electron Spectroscopy for Chemical Analysis (ESCA). A principle thereof is as follows.

If X-ray (photons) with certain energy is incident on the specimen, core level photoelectrons of atoms, which constitute the specimen, are escaped from the specimen. Core level energy, that is, internal bonding energy is different depending on the atoms constituting the specimen. The bonding energy is measured as a difference between initial irradiation energy and photoelectron energy, and the measured energy can be analyzed to confirm elements. Additionally, the energy of the photoelectrons, which are escaped from the element, can also determine atom charges that are provided as a result of chemical bonding. Here, ultraviolet ray is employed instead of X-ray in Ultraviolet Photoelectron Spectroscopy (UPS).

In the meantime, if X-ray is irradiated into the specimen in a high vacuum chamber of an XPS analysis apparatus, the photoelectrons are escaped from the surface of the specimen into an Electron Energy Analyzer to measure the photoelectron energy. Since the photoelectrons escaped from the specimen has much little kinetic energy and a limited mean free path, only photoelectrons escaped from an about 10 nm depth from the surface of the specimen can enter a spectroscopy and can be used as analysis data.

Angle-Resolved X-ray Photoelectron Spectroscopy (ARXPS) is widely used as a non-destructive analysis method for analysing a composition depending on the depth. However, the ARXPS has a drawback in that it provides a two-dimensional analysis result, and it is difficult to expect a three-dimensional result that is a more precisely and reliably analysed result.

### SUMMARY OF THE INVENTION

The present invention provides a method for non-destructive surface analysis in which the surface and the inner of a specimen can be precisely analyzed in three dimensions.

According to an aspect of the present invention, there is provided a method of analyzing a surface three-dimensionally in which compositions of a surface and an inner of a specimen are analyzed in three dimensions in a device having a beam source; a monochromator which separates a specific-wavelength beam from a multi-wavelength beam emitted from the beam source and irradiates the specific-wavelength beam into the specimen; and a detector which analyzes energy of photoelectrons that are excited and escaped from the specimen, the method comprising: irradiating the specific-wavelength beam into one region of the surface of the specimen to measure intensities of the excited photoelectrons depending on escape angles between a normal line to the surface of the specimen and the escape directions of the excited photoelectrons, and detecting a composition distribution depending on a depth of the one region of the specimen by using data on the intensities that are measured depending on the escape angles of the excited photoelectrons; changing an incident position of the specific-wavelength beam for the specimen to detect the composition distribution depending on the depth at each of positions of the surface of the specimen; and collecting data on the composition distribution depending on the depth at each of the positions of the specimen to analyze the compositions of the specimen in the three dimensions.

The beam is X-ray or ultraviolet ray.

The specimen is driven using a stage driver to adjust each of the positions of the surface of the specimen, and the escape angles of the photoelectrons.

The composition distributions depending on each of depths from the surface to the inner of the specimen are measured by adjusting the escape angles of the photoelectrons.

The escape angles of the photoelectrons are selected to have five to eight angles of 0° to 70°.

The intensities depending on the escape angles of the photoelectrons are calculated in the following Equation:

$$I = {I}_{0} {\int }_{0}^{∞} n ( z ) {exp}^{- z / λcosθ} ⅆ z$$

wherein I₀ represents intensity of X-ray that is incident on the surface of the specimen; n(z) represents concentration distributions of the elements depending on the depth of the specimen z; θ represents angles between a normal line to the surface of the specimen and the escape directions of the photoelectrons; and λ represents inelastic mean free path of the photoelectrons.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a device performing a method of analyzing a surface three-dimensionally according to a preferred embodiment of the present invention;

FIGS. 2A and 2B are views illustrating the escape angles of photoelectrons depending on the depth of a specimen when a specific-wavelength beam is irradiated on the surface of the specimen;

FIG. 3 is a view illustrating a relation of the angle between a normal line to the surface of a specimen and the escape directions of photoelectrons, with the depth of the specimen;

FIGS. 4A through 4C are views illustrating an intensity distribution that is measured depending on the escape angles of photoelectrons escaped by the irradiation of X-ray into a specimen;

FIG. 5 is a graph illustrating an energy intensity depending on the escape angles of photoelectrons, which is measured using ARXPS;

FIGS. 6A through 6E are graphs illustrating an element concentration depending on the depth of a specimen, FIG. 6A illustrating a silicon (Si) concentration in a SiOₓN_{y} layer, FIG. 6B illustrating an intrinsic-silicon concentration in a substrate, FIG. 6C illustrating an oxygen (O) concentration, and FIGS. 6D and 6E illustrating nitrogen (N) concentrations that are in different chemical states;

FIG. 6F is a graph illustrating the concentration distribution of an element depending on the depth of a specimen, which is measured using a conventional method for surface analysis;

FIG. 7 is a view illustrating a specimen with a HfO₂ film being formed on a silicon substrate; and

FIGS. 8A through 8F are three-dimensional graphs illustrating the composition of a specimen with the HfO₂ film of FIG. 7, according to a preferred embodiment of a method of analyzing a surface three-dimensionally.

### DETAILED DESCRIPTION OF THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by explaining preferred embodiments of the invention with reference to the attached drawings. Like reference numerals in the drawings denote like elements.

In the present invention, a method for surface analysis using Angle-Resolved X-ray Photoelectron Spectroscopy (ARXPS) employing X-ray will be described. This method can be also applied to surface analysis using Ultraviolet Photoelectron Spectroscopy (UPS) that employs ultraviolet ray instead of X-ray.

When a specimen is analysed using the ARXPS to obtain the result of the element concentration and the chemical bonding degree of the specimen, X-ray is irradiated into the specimen. The X-ray excites the inner shell electrons of elements constituting the specimen to cause the escape of photoelectrons with kinetic energy peculiar to each element. A spectroscopy measures the intensity of photoelectrons depending on the escape angles of photoelectrons, which are escaped from the surface of the specimen. When element distribution is analysed in three dimensions at the surface of the specimen and at a predetermined depth to the inner of the specimen, information on each of positions at the surface of the specimen and information on the inner depth at each of the positions should be obtained.

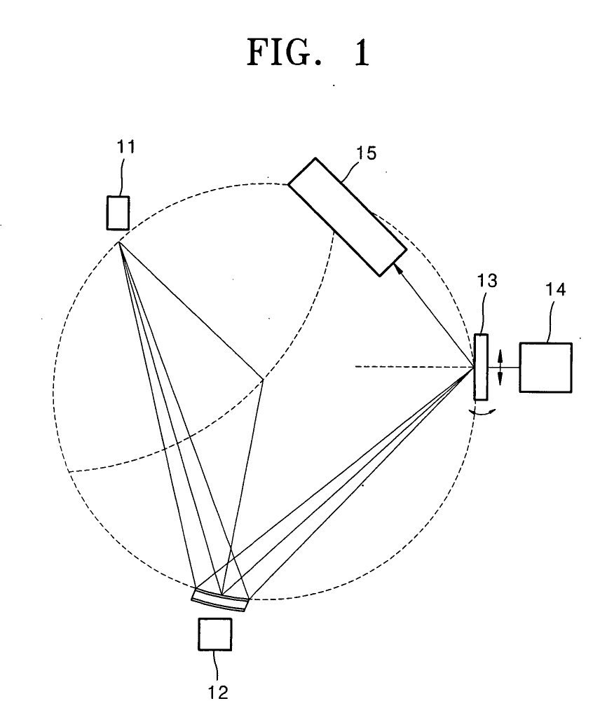

FIG. 1 is a view illustrating a device performing a method of analyzing a surface three-dimensionally according to a preferred embodiment of the present invention.

Referring to FIG. 1, X-ray, which is generated at an X-ray source 11, is irradiated toward a crystal monochromator device, that is, a monochromator 12. The X-ray emitted from the X-ray source 11 is white X-ray with a wide range of wavelength. The monochromator 12 produces a specific wavelength of X-ray to irradiate the specific wavelength of X-ray into the surface of the specimen 13. At this time, the specimen 13 is rotated and tilted by a stage driver 14 to be angled with the incident angle of X-ray. Additionally, the specimen 13 is moved such that the surface position of the specimen, at which X-ray is incident, is changed. Here, the reason why the specific wavelength of X-ray is generated is that energy resolution is increased when the specimen is analyzed. If the specific wavelength of X-ray is irradiated on the surface of the specimen 13, photoelectrons are generated from the specimen 13. The photoelectrons escaped from the specimen 13 are detected at a photoelectron detector 15.

The intensity “I” of the photoelectrons, which is detected at the detector 15, is calculated with a function of a specimen depth “z” as in the following Equation 1:

$$I = {I}_{0} {\int }_{0}^{∞} n ( z ) {exp}^{- z / λcosθ} ⅆ z \qquad Equation 1$$

where
I₀: intensity of X-ray that is incident on the surface of the specimen
n(z): concentration distribution of the elements depending on the depth of the specimen z
θ: angles between a normal line to the surface of the specimen and the escape directions of excited photoelectrons
λ: inelastic mean free path of the photoelectrons depending on an atomic number.

If the energy of the escaped photoelectrons is obtained as described above, information on the chemical bonding of atoms from which the photoelectrons are escaped can be obtained.

If the specific wavelength of X-ray is irradiated into the specimen 13 in FIG. 1, the photoelectrons are excited and escaped from the surface and the inner of the specimen 13. At this time, the specimen 13 is tilted or rotated at a predetermined angle by the stage driver 14. If inner shell electrons, which are distributed at a specific electron orbit of the elements constituting the specimen 13, are excited, the excited inner shell electrons are escaped at a predetermined angle with the normal line to the surface of the specimen 13. The intensity of the electrons, which is detected at a specific angle between the escape directions of the photoelectrons and the normal line to the surface of the specimen 13, can be calculated in the Equation 1 to determine the composition depending on the depth of the specimen 13.

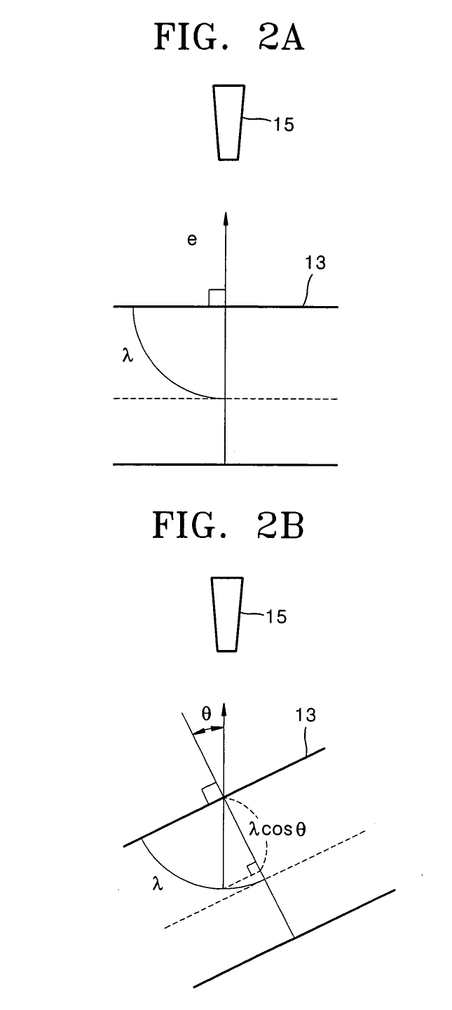

FIGS. 2A and 2B are views illustrating the escape angles of the photoelectrons depending on the depth of the specimen 13 when a specific-wavelength beam is irradiated on the surface of the specimen 13.

If the specific wavelength of X-ray is irradiated into the specimen 13, the photoelectrons of the elements constituting the specimen 13 are escaped from the specimen 13 to an external. At this time, a predetermined angle θ is between the normal line to the surface of the specimen 13 and the forward direction of the escaped photoelectrons. The photoelectrons are escaped from the inner by the mean free path λ of the escaped photoelectrons. Accordingly, the escape depths of the photoelectrons are λ cos θ from the surface of the specimen 13.

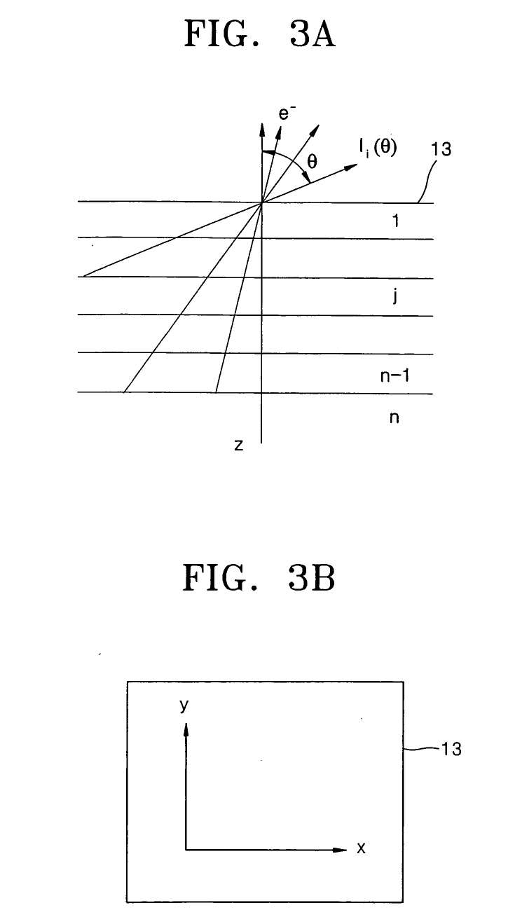

The peak region of the kinetic energy of the photoelectrons is measured through the photoelectron detector 15 at five to eight escape angles of 0°<θ<70°. The element concentration depending on the depth of the specimen can be obtained using the calculated data in a linear equation. For this, the specimen 13 has a multi-layered region that is partitioned in parallel with the surface thereof. This is illustrated in FIG. 3. It is assumed that the elements constituting respective layers of the multi-layered region have a constant concentration sum. The above linear equation is expressed in the following Equation 2:
(A+aU)x=b Equation 2
where
A: transmission function which determines the function of photoelectrons escaping from the specimen at the escape angle θ which passing through the depth z which are produced at depth z in the given layer of the multi-layered region by which the inner of the specimen is partitioned into the multi layer region, that is, quantitative function of the photoelectrons that are escaped from each of the layers of the multi-layered region
b: vector value that is determined by experimental intensities of the photoelectrons
U: regularization function, which is a constraint function for the condition of each of the layers, for finding an optimal value using empirical information
a: regularization parameter that is empirically determined using L-curve analysis.

The transmission function “A” is information on each of the layers that is expressed in a matrix format at the multi-layered region. Since the selection of the regularization function “U” is disclosed in a publication document (Cumpson, P. J., Electron Spectrosc. Related Phenomena, vol. 73, no, pp. 25-52, issued in 1995), a detailed description thereof is omitted. A detailed description for the regularization parameter “a” is disclosed in a publication document (Hansen, P. C., Numerical Algorithms, vol. 6, pp. 1-3, issued in 1994).

Additionally, a depth resolution at the time of analyzing the specimen according to the present invention will be now described.

The depth resolution is defined by the number of the layers, which can partition the specimen 13 from the surface to the predetermined depth thereof when the specimen 13 is analyzed in a multi-layered format using the ARXPS. The escape depths of the photoelectrons are expressed as λ cos θ, and maximal escape depths are expressed as λ in case that cos θ has a value of 1. The number of multi layers, which can partition within a range from the surface of the specimen to the maximal escape depths λ, is the same as that of the angle θ. The depth resolution is determined from the number of multi layers and it is expressed in the following Equation 3:

$$0.4 exp ( ɛ / 8.9 \sqrt{N - 1 )} \leq \frac{Δ Z}{Z} \leq 0.826 exp ( ɛ / 8.9 \sqrt{N - 1} ) \qquad Equation 3$$

where
ε: exactness percentage of a peak at the intensity profile of the escaped photoelectrons
a_{I}: standard variation of the measured escape intensity of the photoelectrons
N: number of the escape angles that correspond to respective peaks for the escaped photoelectrons, that is, the number of the escape angles
Z: specimen depth
ΔZ: the depth resolution

The exactness percentage “ε” is defined as ε=100(a_{I}/I) with “I” representing the intensity of the escape photoelectrons as expressed in the Equation 1.

The XPS or UPS can analyze the specimen to determine the maximal depth of the inner of the specimen by using the inelastic mean free path of the photoelectrons, and the maximal depth is generally 10 nm or less.

After data is obtained on the concentration distribution depending on the depth at one position of the specimen 13, the specimen 13 is precisely adjusted and moved using the stage driver 14 as shown in FIG. 3B. That is, the irradiation position of X-ray is moved in the x-y direction of the specimen 13 such that data on the concentration distribution depending on the depth is obtained at each of positions. After the concentration distributions of the elements are analyzed at each of the positions of the specimen 13, the analyzed concentration distributions are collectively used to obtain data on the three-dimensional concentration distribution.

An experimental example of the surface analysis of the specimen 13 using the ARXPS is in detail described using the above method.

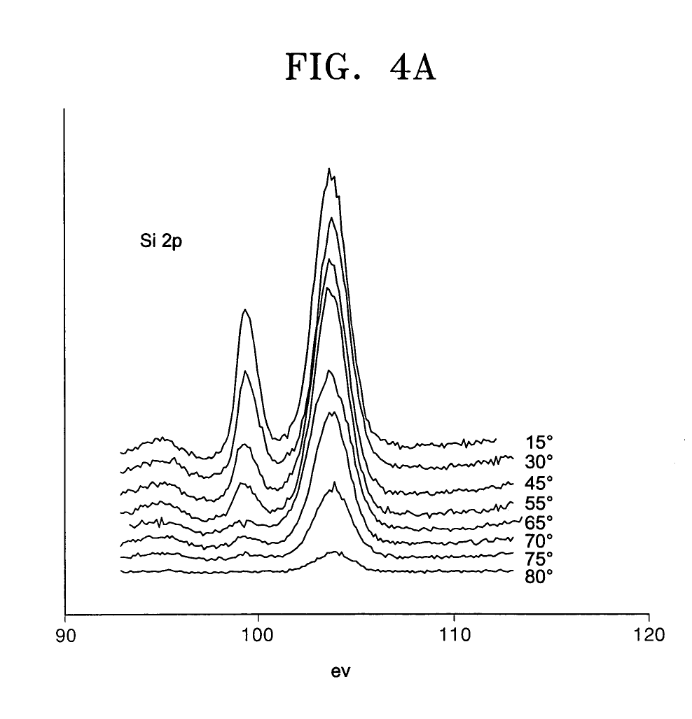

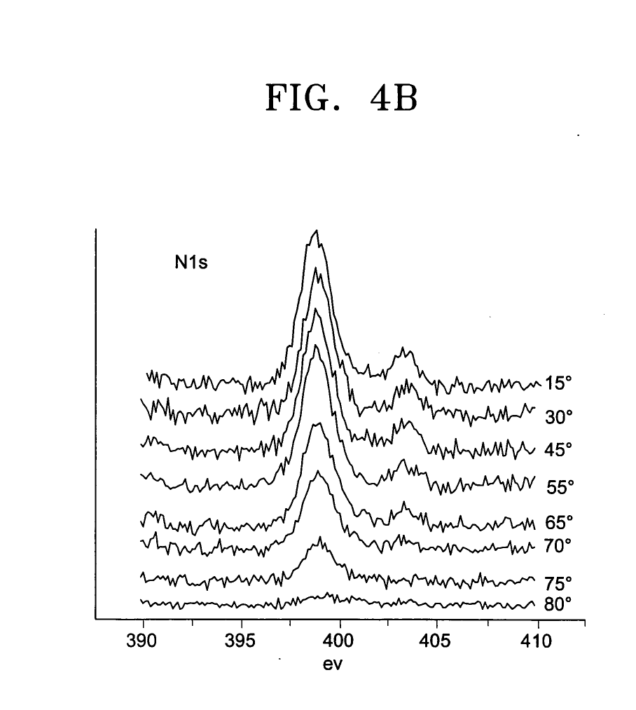

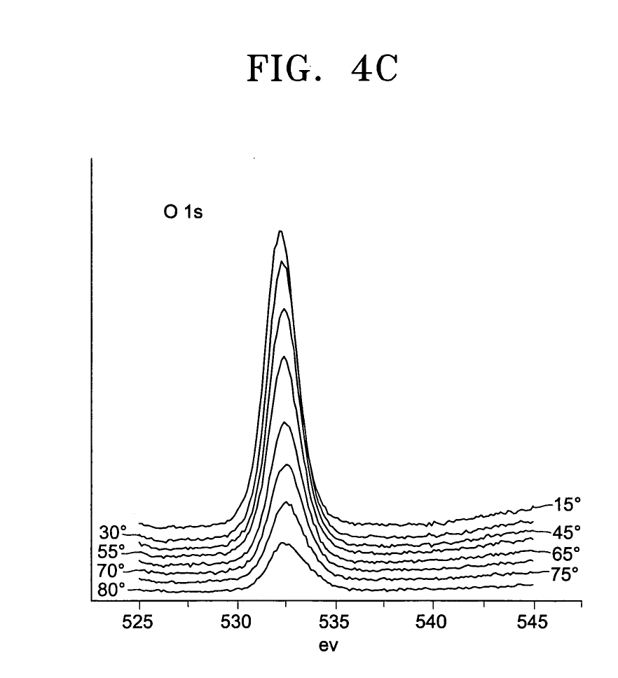

First, four pieces of SiOₓN_{y} (0<x, y<1) specimens are prepared with thicknesses of 0.7 mm. The specimen is formed by forming a SiO₂ layer on a silicon substrate through oxidation and then, doping nitrogen (N₂) into the surface of the SiO₂ layer. First, second, third and fourth specimens have doping depths of 4 nm, 3 nm, 2 nm, and 1.5 nm, respectively. The intensity depending on the escape angles of the photoelectrons, which are escaped by irradiating X-ray into each of the specimens using the ARXPS, is measured and shown in FIGS. 4A through 4C. FIG. 4A illustrates the intensity distribution of the photoelectrons that are escaped from the 2p energy level of silicon (Si 2p).

Here, two peaks are observed at the 2p energy level of silicon (Si 2p). This means that an intrinsic silicon substrate and a silicon oxide substrate are in different chemical states. Additionally, two peaks are also observed at a 1s energy level of nitrogen (N 1s). This means that the nitrogen atoms in N-doped region of the silicon substrate are in a different chemical state.

The lower binding energy N 1s peak(398 eV) originates from the nitrogen atoms connected to three silicon atoms (N—Si₃ configuration); while the higher binding energy peak (403 eV) comes from N atoms bonded to two oxygen atoms and one silicon atom (O₂—N—Si)

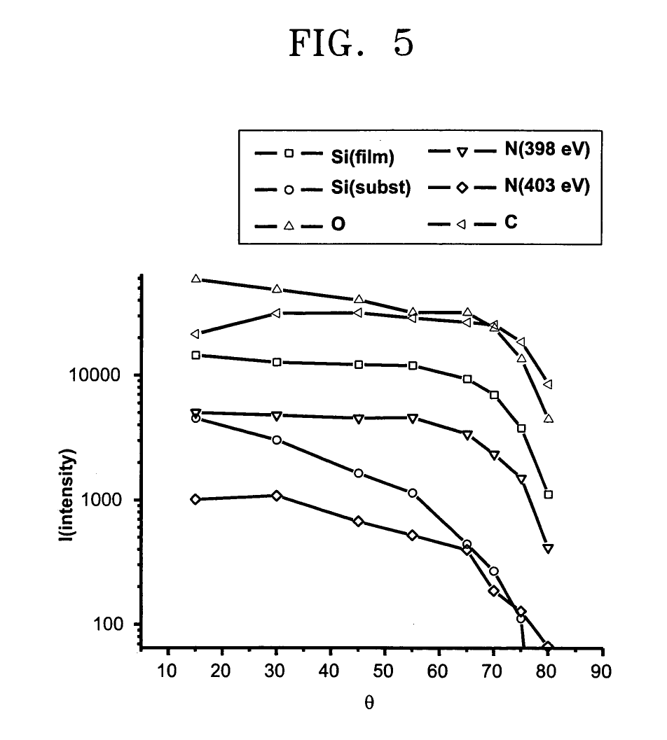

FIG. 5 is a graph illustrating an energy intensity depending on the escape angles of the photoelectrons, which is measured using the ARXPS.

For the application of a regularization technique, it is required to analyze additional information on an ideal result. First, it is assumed that carbon, oxygen, nitrogen and a silicon oxide are distributed only on the surface of the specimen and do not exist at the inner of the specimen. Additionally, it is assumed that intrinsic silicon is distributed at the inner of the specimen. In order to obtain a discrete approximate value, the SiOₓN_{y} layer is partitioned into the multi layers that are in parallel with the surface thereof. A regularization parameter is obtained from an L-curve to calculate the Equation 2.

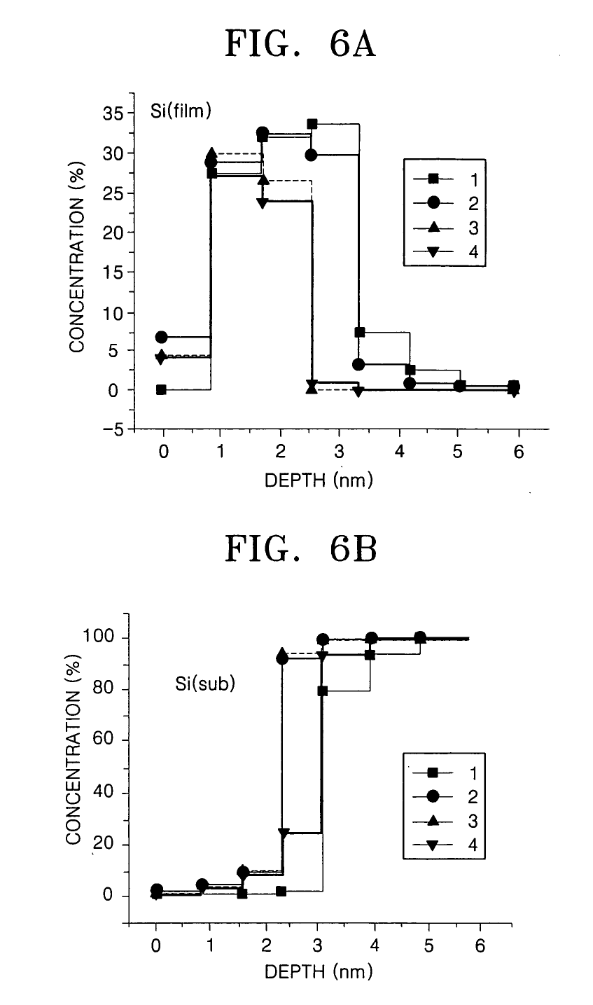

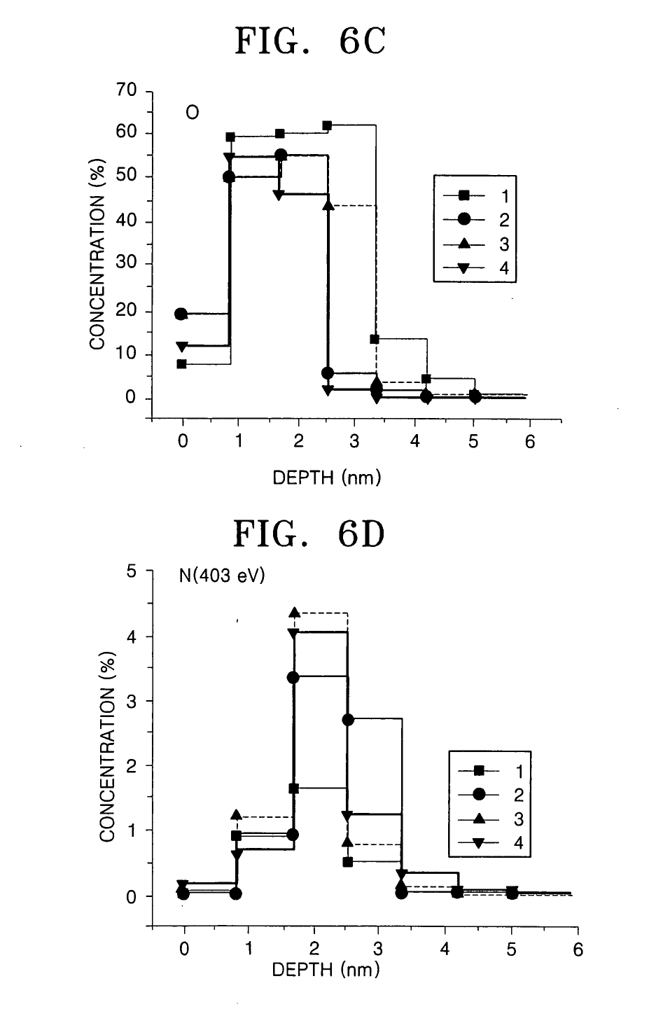

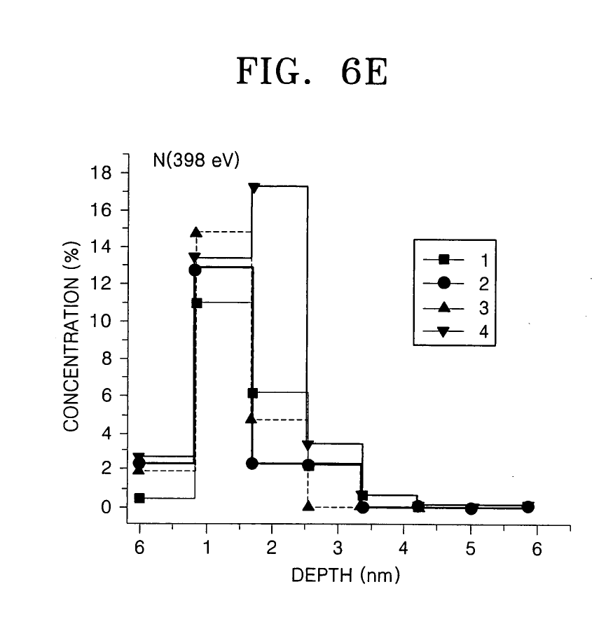

FIGS. 6A through 6E are graphs illustrating an element concentration depending on the depth of the specimen. FIG. 6A illustrating a silicon (Si) concentration in the SiOₓN_{y} layer, FIG. 6B illustrating an intrinsic-silicon concentration in the substrate, and FIG. 6C illustrating an oxygen (O) concentration. FIGS. 6D and 6E illustrating concentrations of nitrogen (N) that is in different chemical states. In FIG. 6D illustrating the concentration distribution depending on the depth of nitrogen having energy of 403 eV, a concentration value is maximized at the interface of the SiOₓN_{y} layer and the intrinsic Si. To the contrary, in FIG. 6E representing the concentration distribution depending on the depth of nitrogen with energy of 398 eV, the concentration distribution is high at a region that is close to the surface of the specimen 13.

If the concentration distribution depending on the depth is combined with the concentration distribution along the surface, information can be obtained on a three-dimensional composition distribution. On the basis of the information, the specimen 13 is rotated and tilted using the stage driver 14 at the time of a measurement using the ARXPS to obtain information on the surface and the depth. FIG. 6F is a graph illustrating the intensity of the photoelectrons having the 1s energy level of nitrogen (N 1s), which is measured using Auger Electron Spectroscopy (AES) that is a conventional destructive analysis method. By a comparative result with FIG. 6E, it will be understood that both have many differences. Considering that the photoelectrons have the intensity proportional to the concentration distribution, it will be understood that the inner structure of the specimen is much destroyed in a conventional analysis experiment.

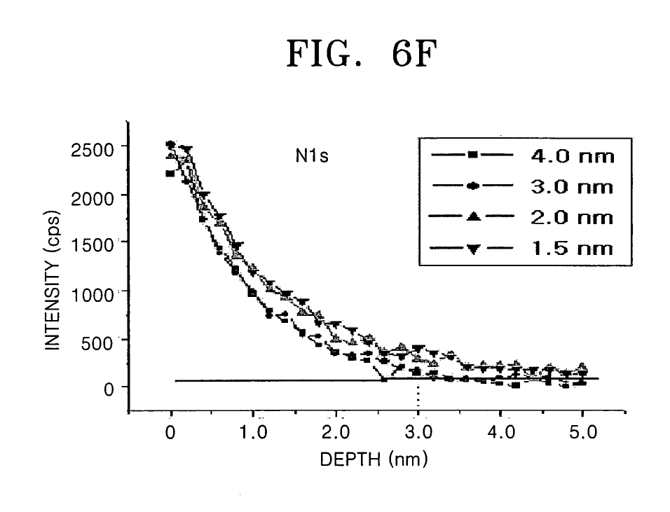

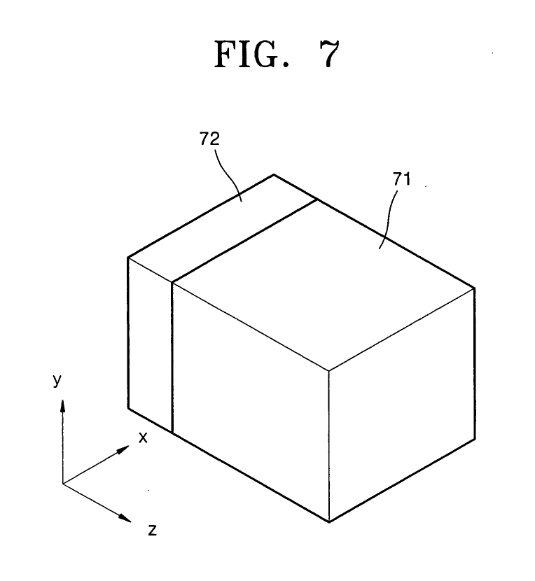

FIG. 7 illustrates the specimen with the HfO₂ film 72 being formed on the silicon substrate 71.

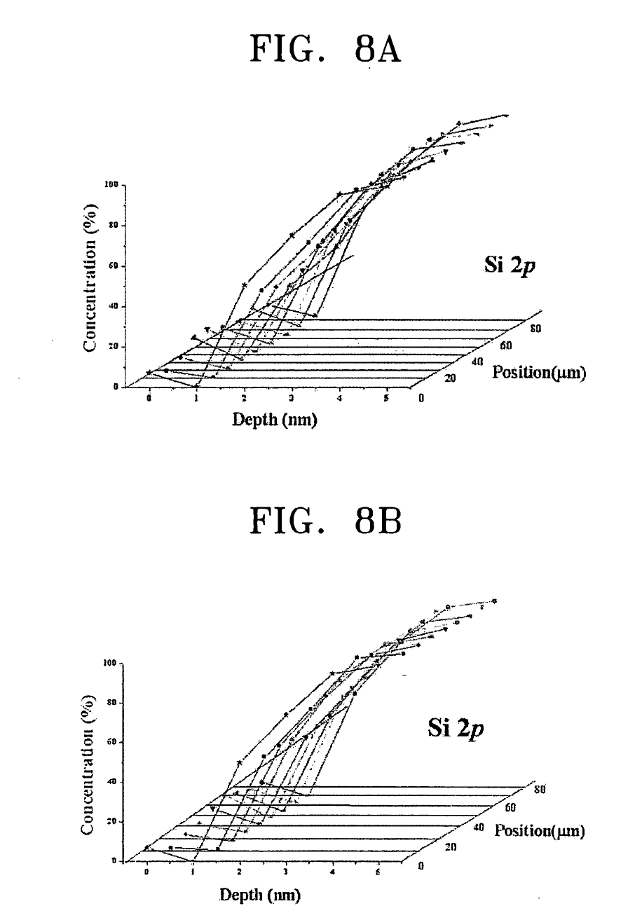

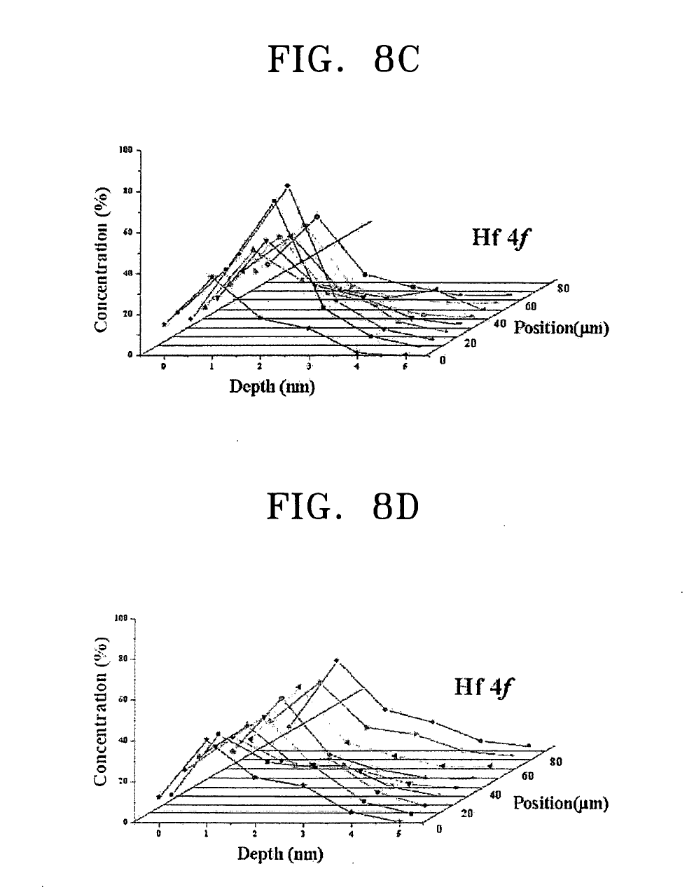

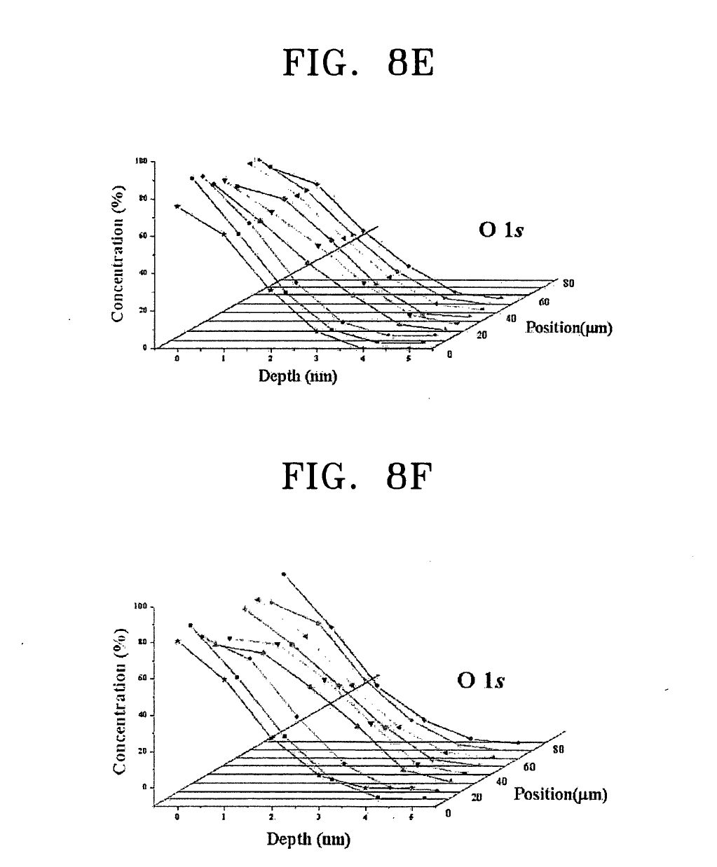

The silicon substrate 71 has an upper surface with a rectangular size of 80 μm×80 μm. The HfO₂ film has a thickness of 6 nm to the maximum. This specimen is analyzed using the method of analyzing a surface three-dimensionally, and its analysis result is illustrated using three-dimensional graph in FIGS. 8A through 8F.

Referring to FIGS. 8A through 8F, silicon does not almost exist at a surface region of the specimen, and does increasingly exist at the deeper inner of the specimen, and has the concentration distribution of almost 100% at the depth of below about 5 nm of the specimen (FIGS. 8A and 8B). Additionally, hafnium (Hf) does exist in small amount (about 10%) at the surface of the specimen, and is concentrated at the depth of 1-3 nm (FIGS. 8C and 8D). Oxygen is concentrated at the surface of the specimen and does not almost exist at the depth region of above 3 nm (FIGS. 8E and 8F).

As described above, when the compositions of the surface and the inner of the specimen is analyzed, the specimen is rotated and tilted for experiment such that the composition distribution depending on each of the positions and the composition distribution depending on the depth at each of the positions can be measured and collected, thereby precisely analyzing the specimen in three dimensions.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of analyzing a surface three-dimensionally in which compositions of a surface and an inner of a specimen are analyzed in three dimensions in a device having a beam source; a monochromator which separates a specific-wavelength beam from a multi-wavelength beam emitted from the beam source and irradiates the specific-wavelength beam into the specimen; and a detector which analyzes energy of photoelectrons that are excited and escaped from the specimen, the method comprising:
irradiating the specific-wavelength beam into one region of the surface of the specimen to measure intensities of the excited photoelectrons depending on escape angles between a normal line to the surface of the specimen and the escape directions of the excited photoelectrons, and detecting a composition distribution depending on a depth of the one region of the specimen by using data on the intensities that are measured depending on the escape angles of the excited photoelectrons;
changing an incident region of the specific-wavelength beam for the specimen to detect the composition distribution depending on the depth at each of regions of the surface of the specimen; and
collecting data on the composition distribution depending on the depth at each of the regions of the specimen to analyze the compositions of the specimen in the three dimensions.

2. The method of claim 1, wherein the beam is X-ray or ultraviolet ray.

3. The method of claim 1, wherein the specimen is driven using a stage driver to change the incident region of the surface of the specimen, and to change the escape angles of the photoelectrons.

4. The method of claim 1, wherein the composition distributions depending on each of depths from the surface to the inner of the specimen are measured by changing the escape angles of the photoelectrons.

5. The method of claim 4, wherein the escape angles of the photoelectrons are selected to have five to eight angles of 0° to 70°.

6. The method of claim 1, wherein the intensities depending on the escape angles of the photoelectrons are calculated in the following Equation:
$$I = {I}_{0} {\int }_{0}^{∞} n ( z ) {exp}^{- z / λcosθ} ⅆ z$$
wherein I₀ represents intensity of specific-wavelength beam that is incident on the surface of the specimen; n(z) represents concentration distributions of the elements depending on the depth z of the specimen; θ represents angles between a normal line to the surface of the specimen and the escape directions of the photoelectrons; and λ represents inelastic mean free path of the photoelectrons.

7. The method of claim 1, wherein the specimen is analyzed at a depth of about 10 nm or less from the surface of the specimen.
